(19) United States
(12) Patent Application Publication
(10) Pub. No.: US 2010/0192002 A1
(43) Pub. Date: Jul. 29, 2010

(54) METHOD AND APPARATUS OF TESTING DATA COMMUNICATION PERFORMANCE OF A NETWORK SYSTEM

(76) Inventors: Yu Su, Beijing (CN); Jun Qiu, Beijing (CN); Xu Zhang, Beijing (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/532,142

(22) PCT Filed: Mar. 26, 2007
(86) PCT No.: PCT/CN07/00969

§ 371 Date: Mar. 25, 2010

(51) Int. Cl. G06F 1/12; G06F 15/16

(52) U.S. Cl. 713/400; 709/248

(57) ABSTRACT

Machine-readable media, methods, apparatus and system for testing a data communication performance of a network system are described. In some embodiments, an apparatus may comprise a first channel to synchronize a local clock of the apparatus with another local clock of another apparatus by communicating a synchronization message with the another apparatus through a first connection. The apparatus may further comprise a second channel to analyze a transceiving activity performed by the apparatus through a second connection and a timestamp of the transceiving activity, wherein the timestamp is made based upon the local clock.

### BACKGROUND

Open systems interconnection (OSI) model is a layered, abstract description for communications and computer network protocol design, developed as part of the Open Systems Interconnection initiative. It is also called the OSI seven layer model: application layer (layer 7), presentation layer (layer 6), session layer (layer 5), transport layer (layer 4), network layer (layer 3), data link layer (layer 2) and physical layer (layer 1). Data link layer is further divided into logical link control (LLC) sub-layer and media access control (MAC) sub-layer. MAC data communication protocol may provide addressing and channel access control mechanisms that may make it possible for several terminals or network nodes to communicate on a multipoint network.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a network system that connecting several terminals through a local area network (LAN) as well as a wireless local area network (WLAN).

FIG. 2 illustrates an embodiment of a terminal.

FIG. 3 illustrates an embodiment of a method of testing data communication performance of the network system.

### DETAILED DESCRIPTION

The following description describes techniques for testing data communication performance of a network system. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the present invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

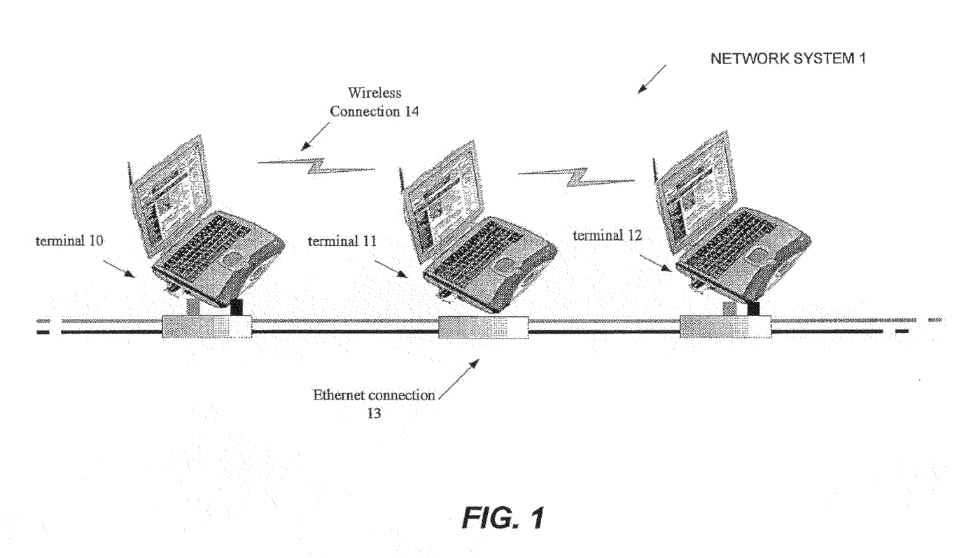

FIG. 1 shows an embodiment of a network system 1. As shown, the network system 1 may comprise several terminals, e.g., terminal 10, terminal 11 and terminal 12. Terminals 10-12 may communicate with each other through an Ethernet connection 13 and/or wireless connection 14. Examples for the terminal may comprise mainframe computer, mini-computer, personal computer, portable computer, laptop computer and other devices for transceiving and processing data. Herein, “transceiving” may comprise sending and/or receiving.

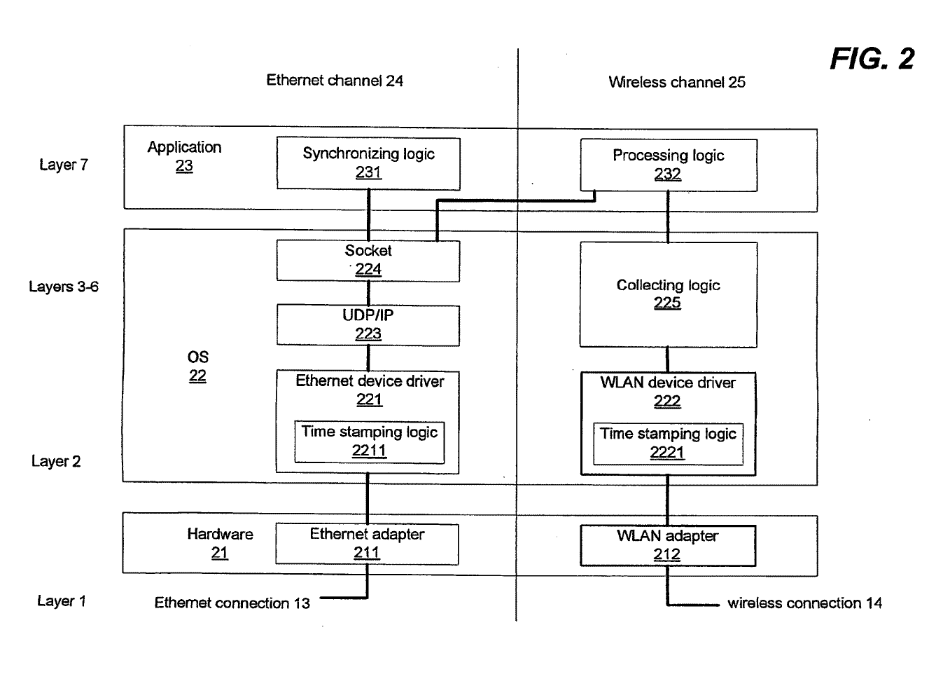

FIG. 2 shows an embodiment of the terminal as shown in FIG. 1. As shown, the terminal (e.g., terminal 10) may comprise hardware 21 and software running over hardware 21 including an operating system 22 and application 23.

Hardware 21 may comprise a network interface, for example, Ethernet adapter 211 to allow the terminal to access local area network (LAN) and communicate with other terminals through Ethernet connection 13, and WLAN adapter 212 to allow the terminal to access wireless local area network (WLAN) and communicate with other terminals through wireless connection 14. It should be appreciated that hardware 21 may comprise other components, for example, one or more processors, a memory and other I/O devices (e.g., keyboard, mouse, antenna), although they are not depicted in FIG. 2 for simplicity.

Operating system 22 may control tasks that the terminal carries out and manages system resources to optimize performance. Operating system 22 may comprise Ethernet device driver 221 to control tasks that Ethernet adapter carries out, such as sending or receiving an Ethernet packet through Ethernet connection 13. Ethernet device driver 221 may further comprise a time stamping logic 2211 to timestamp the sending/receiving of the Ethernet packet by Ethernet adapter 211 based upon a local clock (not shown) of the terminal.

As shown in FIG. 2, Ethernet adapter 211 and Ethernet device driver 221 may form a data link layer (i.e., layer 2) for the local area network (LAN) that may enables terminals to communicate through Ethernet connection 13. Layer 2 may translate logical information from upper layer (e.g., layer 3) into actual electrical pulse that may travel over a physical layer (i.e., layer 1). Layer 2 may further comprise logical link control (LLC) sub-layer (not shown in FIG. 2) and media access control (MAC) sub-layer (not shown in FIG. 2).

LLC sub-layer may manage communications between the terminals over a single link of the network. LLC communication protocol may define a number of fields in data link layer frames that allow multiple higher layer protocols to share a single physical data link. MAC sub-layer may manage protocol access to the physical medium. MAC communication protocol may provide addressing and channel access control mechanisms that may make it possible for the terminals to communicate within the network.

Operating system 22 may further comprise UDP/IP 223 and socket 224 that may compose layers 3-6. Layers 3-6 may interface between upper layer (i.e., layer 7) and lower layer (i.e., layer 2) and perform abstraction and isolation of the upper layer from the lower layer.

UDP/IP 223 may encapsulate data from the upper layer based upon UDP/IP protocol for the lower layer to navigate the data on the network. UDP/IP 223 may further de-capsulate the data from the lower layer based upon UDP/IP protocol for the upper layer to interact with application program and provide services for the application programs. It should be appreciated that other protocols could be used in place of UDP/IP, for example, TCP/IP.

Socket 224 may be “equal to” a network interface (not physically, but metaphorically) to allow a network application to “plug into” the network. Socket 224 may be used by a process to communicate with other terminals via a transport protocol.

Application 23 running above operating system 22 may comprise synchronizing logic 231 to synchronize the local clock of the terminal with local clocks of other terminals of the network system 1, for example, with the local clocks (not shown) of terminals 11 and 12. Various protocols may be used to implement the synchronization, for example, precision time protocol (PTP).

Synchronizing logic 231 may generate a PTP message to be sent to other terminals via Ethernet connection 13. Time stamping logic 2211 may timestamp the sending of the PTP message from the terminal to the other terminals. Synchronizing logic 231 may further analyze the PTP message received from other terminals and the timestamp of the receiving of the PTP message and adjust the local clock to be synchronized with other local clocks of the other terminals based upon the analysis result.

Operating system 22 may further comprise WLAN device driver 222 to control tasks that WLAN adapter 212 carries out, such as sending or receiving a wireless packet through wireless connection 14. WLAN device driver 222 may further comprise a time stamping logic 2221 to timestamp the sending/receiving of the wireless packet based upon the local clock of the terminal.

As shown in FIG. 2, WLAN adapter 212 and WLAN device driver 222 may form layer 2, i.e., data link layer for the wireless local area network (WLAN) that may enable the terminals to communicate through wireless connection 14. Functionality of layer 2 for the wireless local area network is similar as that for the local area network and will not be reiterated for simplicity.

Operating system 22 may further comprise collecting logic 225 that may collect wireless packets transceived by the terminal and pass the wireless packets between the upper layer (layer 7) and the lower layer (layer 2). Dissimilarly with UDP/IP 223 and socket 224, collecting logic 225 may pass the wireless packets between the upper layer and the lower layer with less or even no processing of the packets.

Application 23 may further comprise processing logic 232. Processing logic 232 may analyze the wireless packets transceived by the terminal and a timestamp of the tranceiving of each wireless packet recorded by the WLAN device driver. Processing logic 232 may further analyze records received from other terminals on the network system 1. The records may describe transceiving activities performed by the other terminals and a timestamp of each tranceiving activity.

Based upon the analysis result, processing logic 232 may detect if any problems exist in layer 2 and/or layer 1 and optimize protocols used for layer 2 and/or layer 1. For example, processing logic 232 may optimize the MAC communication protocol and/or LLC communication protocol based upon the analysis result.

It can be seen from FIG. 2 and the above descriptions that the terminal may comprise two channels: Ethernet channel 24 to synchronize the local clock of the terminal with the local clocks of other terminals on the network system; and wireless channel 25 to analyze transceiving activities performed by the terminal and the other terminals as well as the timestamp of each transceiving activity recorded with the synchronous clocks of the terminals on the network system.

Ethernet adapter 211, Ethernet device driver 221, UDP/IP 223, socket 224 and synchronizing logic 231 may make up of Ethernet channel 24. WLAN adapter 212, WLAN device driver 222, collecting logic 225 and processing logic 232 may make up of wireless channel 25. With such scenario, the terminal may obtain not only the transceiving performance of the terminal itself, but also the transceiving performance of other terminals so that the terminal may detect any transceiving problems existing in the network and optimize the data communication protocol of the network system.

Ethernet channel 24 may communicate packets through wireless channel 25. For example, Ethernet channel 24 may send a management packet to wireless channel 25 (e.g., processing logic 232) to instruct the wireless channel 25 to send or receive the wireless packets. For another example, Ethernet channel 24 may receive the record of transceiving activities from other terminals on the network system.

Other embodiments may implement other technologies for the terminal as shown in FIG. 2. For example, except Ethernet technology, the local area network may enable the terminals to communicate based upon other technologies, such as token ring technology. For another example, wireless channel 25 may use functional units as similar as layers 3-6 of Ethernet channel 24, rather than passing the wireless packets with less or no data processing. In such case, processing logic 232 may detect if any problems exist in layers 3-6 as well as problems in layers 1-2.

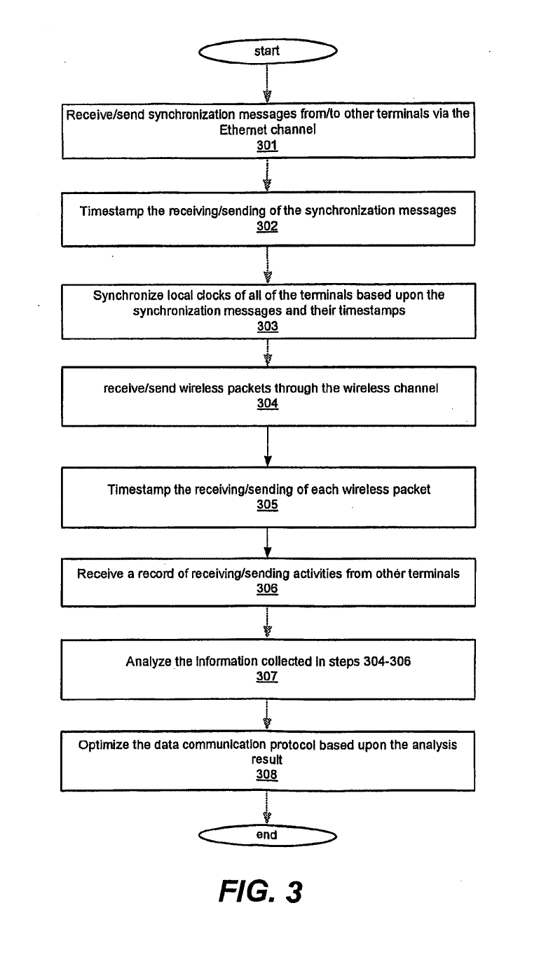

FIG. 3 illustrates an embodiment of a method of testing data communication performance of the network system. In block 301, Ethernet channel 24 of the terminal (e.g., terminal 10) may receive/send synchronization messages from/to other terminals (e.g., terminals 11-12) within the network. In block 302, the time stamping logic of Ethernet channel 24 may timestamp the receiving/sending of the synchronization messages. In block 303, Ethernet channel 24 may synchronize local clocks of some or all of the terminals on the network based upon the synchronization messages and their timestamps. Ethernet channel 24 may use various technologies to perform the synchronization, such as PTP protocol.

In block 304, wireless channel 25 of the terminal (e.g., terminal 10) may receive/send the wireless packets from/to other terminals (e.g., terminals 11-12) on the network. In block 305, wireless channel 25 may timestamp the receiving/sending of each wireless packet. In block 306, wireless channel 25 may receive a record from other terminals on the network system. The record may describe receiving/sending activities performed by the other terminals as well as the timestamp of each receiving/sending activity.

In block 307, the terminal may analyze the information collected in blocks 304-306. For example, wireless channel 25 may analyze not only the receiving/sending activities performed by the terminal itself, but also the receiving/sending activities performed by other terminals on the network system, so as to detect any problems related to data communication protocols adopted by the network system or optimize the mechanism of data communication protocols. Based upon the analysis result, wireless channel 25 may optimize the data communication protocols and improve the data communication performance of the network system in block 308.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. An apparatus, comprising:
a first channel to synchronize a local clock of the apparatus with another local clock of another apparatus by communicating a synchronization message with the another apparatus through a first connection; and
a second channel to analyze a transceiving activity performed by the apparatus through a second connection and a timestamp of the transceiving activity, wherein the timestamp is made based upon the local clock.

2. The apparatus of claim 1, wherein the second channel further analyzes a record received from the another apparatus, wherein the record describes another transceiving activity performed by the another apparatus through the second connection and another timestamp of the another transceiving activity, wherein the another timestamp is made based upon the another local clock.

3. The apparatus of claim 2, wherein the first channel further receives the record from the another apparatus through the first connection.

4. The apparatus of claim 2, wherein the second channel further optimizes a media access control (MAC) protocol based upon an analysis of the transceiving activity, the timestamp of the transceiving activity, the another transceiving activity and the another timestamp of the another transceiving activity.

5. The apparatus of claim 1, wherein the first connection is an Ethernet connection and the second connection is a wireless connection.

6. The apparatus of claim 1, wherein the first channel uses a precision time protocol (PTP) to synchronize the local clock with the another local clock.

7. The apparatus of claim 1, wherein the first channel comprises:
a first adapter to couple the apparatus to the first connection and transceive the synchronization message through the first connection;
a first device driver to control the first adapter and timestamp a transceiving of the synchronization message to provide a synchronization timestamp; and
a synchronization logic to analyze the synchronization message and the synchronization timestamp to synchronize the local clock with the another local clock.

8. The apparatus of claim 1, wherein the second channel comprises:
a second adapter to couple the apparatus to the second connection and transceive a packet through the second connection;
a second device driver to control the second adapter and timestamp a transceiving of the packet to provide the timestamp; and
a processing logic to analyze the packet and the timestamp to optimize a media access control (MAC) protocol.

9. A machine-readable medium comprising a plurality of instructions which when executed result in an apparatus:
synchronizing a local clock of the apparatus with another local clock of another apparatus by communicating a synchronization message with the another apparatus through a first connection; and
analyzing a transceiving activity performed by the apparatus through a second connection and a timestamp of the transceiving activity, wherein the timestamp is made based upon the local clock.

10. The machine-readable medium of claim 9, wherein the plurality of instructions further result in the apparatus:
analyzing a record received from the another apparatus, wherein the record describes another transceiving activity performed by the another apparatus through the second connection and another timestamp of the another transceiving activity, wherein the another timestamp is made based upon the another local clock.

11. The machine-readable medium of claim 10, wherein the plurality of instructions further result in the apparatus:
receiving the record from the another apparatus through the first connection.

12. The machine-readable medium of claim 10, wherein the plurality of instructions further result in the apparatus:
optimizing a media access control (MAC) protocol based upon an analysis of the tranceiving activity, the timestamp of the transceiving activity, the another transceiving activity and the another timestamp of the another transceiving activity.

13. The machine-readable medium of claim 9, wherein the first connection is an Ethernet connection.

14. The machine-readable medium of claim 9, the second connection is a wireless connection.

15. The machine-readable medium of claim 9, wherein the first channel uses a precision time protocol (PTP) to perform the synchronization.
